(19) United States
(12) Patent Application Publication
(10) Pub. No.: US 2021/0246993 A1
(43) Pub. Date: Aug. 12, 2021

(54) Valve Actuator and Valve

(71) Applicant: Buerkert Werke GmbH & Co. KG, Ingelfingen (DE)

(72) Inventor: Micah HODGINS, Ingelfingen (DE)

(21) Appl. No.: 17/173,223

(22) Filed: Feb. 11, 2021

(30) Foreign Application Priority Data
Feb. 11, 2020 (DE) 10 2020 103 474.1

(51) Int. Cl. F16K 31/02; F16K 37/00

(52) U.S. Cl. CPC F16K 31/02; F16K 37/0025

(57) ABSTRACT

A valve actuator (18) for a valve (10) is described, comprising a dielectric elastomer converter module (20) having two opposite ends (20a, 20b). Each end (20a, 20b) is provided with at least one connection element (22) for coupling the valve actuator (18) to a retaining part (24) and an actuating part (26) of the valve (10), respectively. Each end (20a, 20b) is connected to the respectively associated connection element (22) via an adhesive bond. Furthermore, a valve (10) having such a valve actuator (18) is presented.

The invention relates to a valve actuator for a valve, comprising a dielectric elastomer converter module having two opposite ends, each end being provided with at least one connection element for coupling the valve actuator to a retaining part or an actuating part of the valve, respectively.

Furthermore, the invention relates to a valve having such a valve actuator.

Such valve actuators and valves equipped therewith are known from the prior art.

A dielectric elastomer converter module comprises at least two mostly planar electrodes which are arranged on both sides of a dielectric, i.e. electrically non-conductive elastomer film. The elastomer film can be compressed in a defined manner depending on the voltage applied between the electrodes, as a result of which it is accordingly elongated while maintaining its volume. The dielectric elastomer converter module thus converts electric energy into mechanical work. Due to the use of an elastomer film, dielectric elastomer converter modules are often also referred to as film converter or, more generally, as electroactive composite structure. Valve actuators having dielectric elastomer converter modules often have a striped shape. Therefore, they may also be referred to as valve actuator strips. In this context, elastomer converter modules may have a single-layer or multilayer structure, i.e. comprise one or more layers having each one pair of electrodes and an associated elastomer film.

The invention is based on the object to further improve known valve actuators. In particular, they should be simple and cost-effective to manufacture. At the same time, such valve actuators should require only a comparatively small installation space.

The object is achieved by a valve actuator of the type initially mentioned, in which each end is connected to the respectively assigned connection element via an adhesive bond. In this way, the dielectric elastomer converter module is particularly reliably connected to the assigned connection elements. In particular in comparison with known valve actuators, in which the dielectric elastomer converter module is connected to the respectively assigned connection elements by clamping, the adhesive bond requires only a comparatively small installation space. Therefore, a valve actuator according to the invention is in particular very flat. Furthermore, the adhesive bond can easily be formed in that an assigned bonding process can be easily automated. In addition, the adhesive bond does not require any additional parts in the form of coupling elements.

The adhesive bond may be in the form of an adhesive layer. To this end, a silicone adhesive is for example used. Alternatively, the adhesive bond can comprise double-sided adhesive strips. In this alternative, it is thus not necessary to incorporate any liquid adhesive into the contact point between the connection element and the dielectric elastomer converter module, but only necessary to apply an appropriate adhesive strip.

The connection elements are preferably identical parts. The connection elements used at opposite ends, taken alone, thus have an identical structure. This simplifies the manufacture of the connection elements, as scale effects can be used. Therefore, the manufacturing costs are in particular reduced.

The dielectric elastomer converter module may be electrically coupled to at least one connection element. More precisely, at least one electrode of the dielectric elastomer converter module is thus electrically coupled to the connection element. This electrode is therefore supplied with voltage via the connection element. Therefore, both the mechanical and the electrical coupling take place via the connection element. This saves space. In addition, the electrical coupling and the mechanical coupling can be realized in a single or in directly successive manufacturing steps. As a result, the valve actuator can be manufactured quickly and easily.

According to a preferred variant, that area of the connection element which serves for electrical coupling and the adhesive bond are located on the same side of a connection element body of the connection element. Thus, both the electrical and mechanical connection of the dielectric elastomer converter module can be realized from the same side. This makes the manufacture of the valve actuator comparatively simple.

In one embodiment, the dielectric elastomer converter module is electrically connected to an electrical conductor track and/or an electrically conductive coating section of the connection element. The conductor track can be applied to the connection element or incorporated into the connection element. Both require very little installation space. The same applies to the coating section. In this context, the conductor track and/or the coating section can be further created in the course of manufacturing the connection element. This also allows an overall simple and cost-effective manufacture of the valve actuator.

Furthermore, the dielectric elastomer converter module may be electrically coupled to the at least one connection element via a conductive paste section and/or an electrically conductive adhesive section. In the case where a conductor track and/or an electrically conductive coating section is/are provided on the connection element, the conductive paste section and/or the electrically conductive adhesive section may be electrically connected to the conductor track and/or the coating section. In other words, an electrode of the dielectric elastomer converter module is electrically connected to the conductor track and/or the conductive coating section via the conductive paste section and/or the electrically conductive adhesive section. Cables or other electrical coupling elements are not required therefor. Since conductive paste sections and adhesive sections can be applied to the connection element in an automated manner, a fast and easy manufacturability of the valve actuator is achieved.

In one variant, each of the connection elements also has a coupling section for mechanical connection to the retaining part and/or to the actuating part of the valve. For this purpose, the coupling section may have at least one opening for screws and/or pins. In this way, it is possible to couple the valve actuator to a valve in a mechanically reliable manner.

Preferably, the connection element is substantially plate-shaped. An adhesive surface is in particular provided to form the adhesive bond. The plate-shape form involves that the valve actuator is generally very flat and thus requires only little installation space. The adhesive surface which is in particular extremely flat compared to known clamping connections, also contributes thereto. Furthermore, a mechanically resilient and reliable connection can be realized by means of the adhesive surface.

The dielectric elastomer converter module may be single-layered or multilayered. A single-layer dielectric elastomer converter module is understood to be an assembly comprising only one pair of electrodes and an elastomer film located therebetween. Accordingly, multilayer dielectric elastomer converter modules comprise two or more pairs of electrodes having associated elastomer films. It is understood that in multilayer dielectric elastomer converter modules, individual electrodes can also be used to compress a plurality of, in particular two elastomer films arranged on opposite sides of the electrode.

Preferably, a modulus of elasticity of the connection element is greater than a modulus of elasticity of the adhesive bond. In particular, the modulus of elasticity of the adhesive bond is greater than a modulus of elasticity of the dielectric elastomer converter module. Thus, the connection element is stiffer than the adhesive bond. The adhesive bond in turn is stiffer than the dielectric elastomer converter module. In other words, the adhesive bond creates a good stiffness transition from the dielectric elastomer converter module to the connection element. The valve actuator thus operates particularly reliably and is mechanically resilient.

Each end of the elastomer converter module may be provided with a total of two connection elements, each end being positioned between the respectively associated connection elements. The two connection elements associated with one end are thus positioned on opposite sides of the end. In this way, a particularly stable connection of the valve actuator to an associated valve can be created.

According to one embodiment, a further dielectric elastomer converter module is provided which extends substantially parallel to the dielectric elastomer converter module. Ends of the elastomer converter modules corresponding to each other are each connected to the same connection element. The valve actuator thus comprises two dielectric elastomer converter modules arranged in parallel. A total of two connection elements are provided for connecting this valve actuator, two ends of the two dielectric elastomer converter modules corresponding to each other being connected via each connection element. A comparatively large actuating force can be generated via the two dielectric elastomer converter modules.

A plurality of parallel dielectric elastomer converter modules may also be provided, adjacent ends of the elastomer converter modules each receiving a connection element therebetween. In particular, the ends of externally located elastomer converter modules are each connected to two connection elements. The valve actuator thus comprises a layered structure of a plurality of elastomer converter modules which are adapted to be connected to a valve via a plurality of connection elements. In particular, the number of connection elements used at one end of the layered structure is one greater than the number of dielectric elastomer converter modules used. Therefore, the valve actuator can be adjusted comparatively freely with respect to the actuating force provided thereby by providing a corresponding number of elastomer converter modules.

Advantageously, a connection element body of the connection element is made of an electrically non-conductive material, in particular a ceramic material or a plastic material. The valve actuator can thus also be used in applications in which it is exposed to electric and/or magnetic fields. Preferably, the connection element body is made of PET, in particular a PET film.

According to one embodiment, the invention relates to a valve actuator for a valve, comprising a dielectric elastomer converter module having two opposite ends, each end being provided with at least one connection element for coupling the valve actuator to a retaining part and an actuating part of the valve, respectively, characterized in that each end is connected to the respectively associated connection element via an adhesive bond, the elastomer converter module being formed from a plurality of stacked layers, the direction in which the layers lie one on top of the other being perpendicular to the direction in which the elastomer converter module acts during operation. Therefore, the adhesive joints between the stacked layers are loaded only in shear, which is advantageous for the load capacity and fatigue strength of the adhesive joints.

Furthermore, the object is achieved by a valve of the type initially mentioned, which comprises a valve actuator according to the invention, a first connection element being coupled to a retaining part and a second connection element being coupled to an actuating part of the valve. Due to the compact design of the valve actuator, the valve can also have a compact structure. Furthermore, due to the simple and cost-effective manufacturability of the valve actuator, a generally simple and cost-effective manufacture of the valve can also be achieved.

The invention is explained below with reference to various example embodiments shown in the accompanying drawings, in which:

FIG. 1 shows a lateral view of a valve according to the invention having a valve actuator according to the invention,

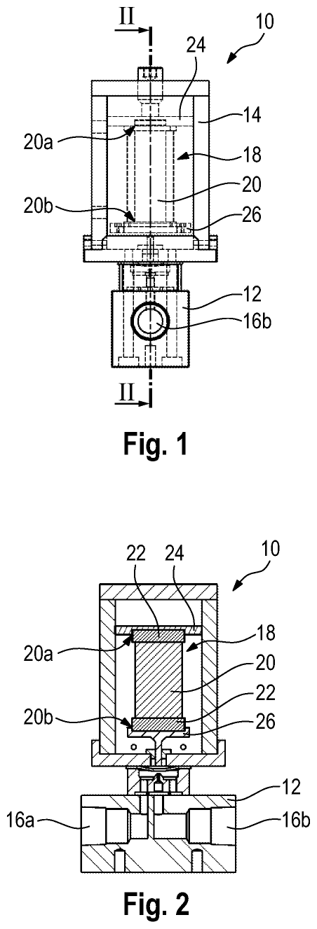

FIG. 2 shows a second embodiment of the valve of FIG. 1 in a lateral view along the plane II-II,

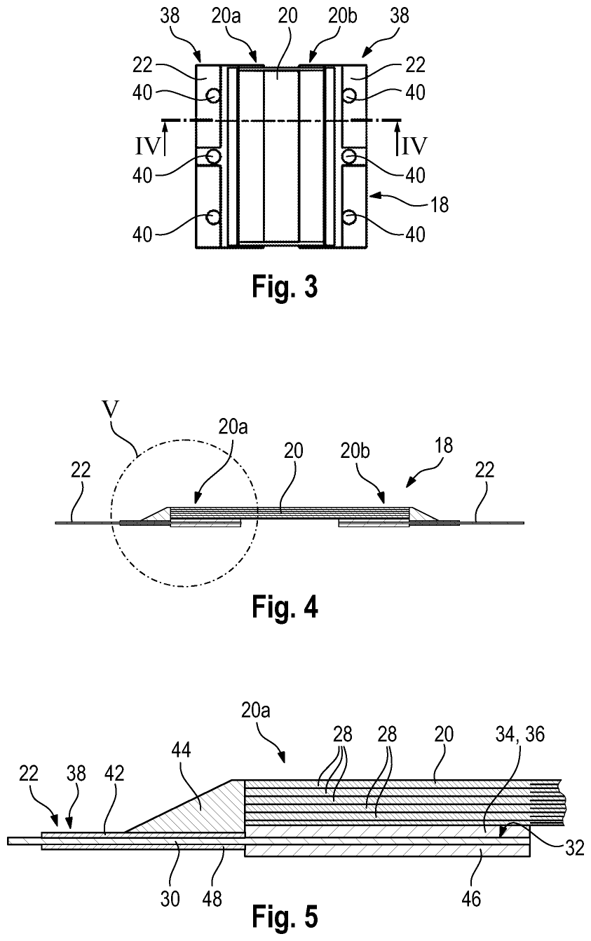

FIG. 3 shows a top view of a valve actuator according to the invention in accordance with a first embodiment,

FIG. 4 shows the valve actuator of FIG. 3 in a sectional view along the plane IV-IV,

FIG. 5 shows a detail V of the valve actuator of FIG. 4,

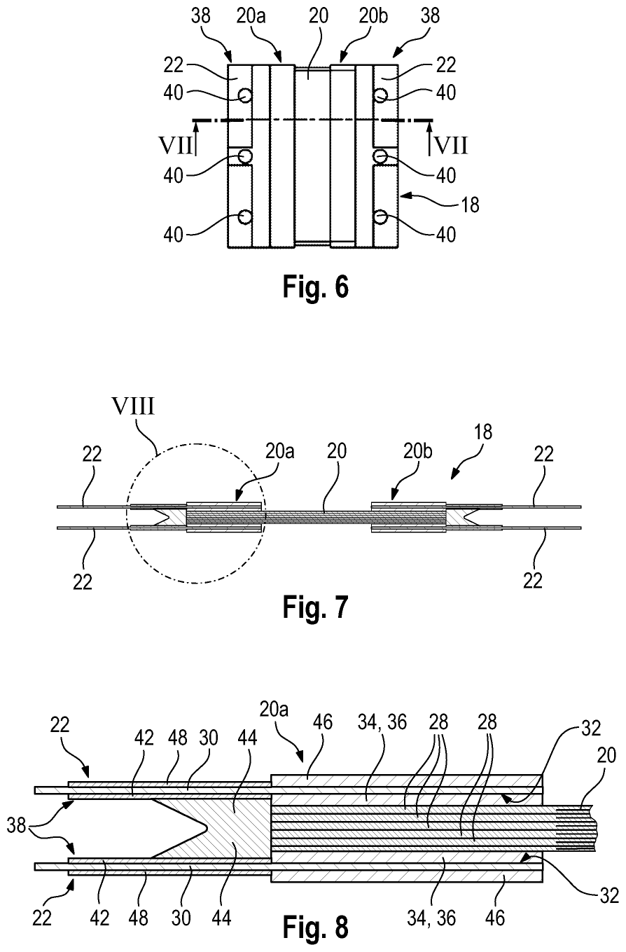

FIG. 6 shows a top view of a valve actuator according to the invention in accordance with a second embodiment,

FIG. 7 shows the valve actuator of FIG. 6 in a sectional view along the plane VII-VII,

FIG. 8 shows a detail VIII of the valve actuator of FIG. 7,

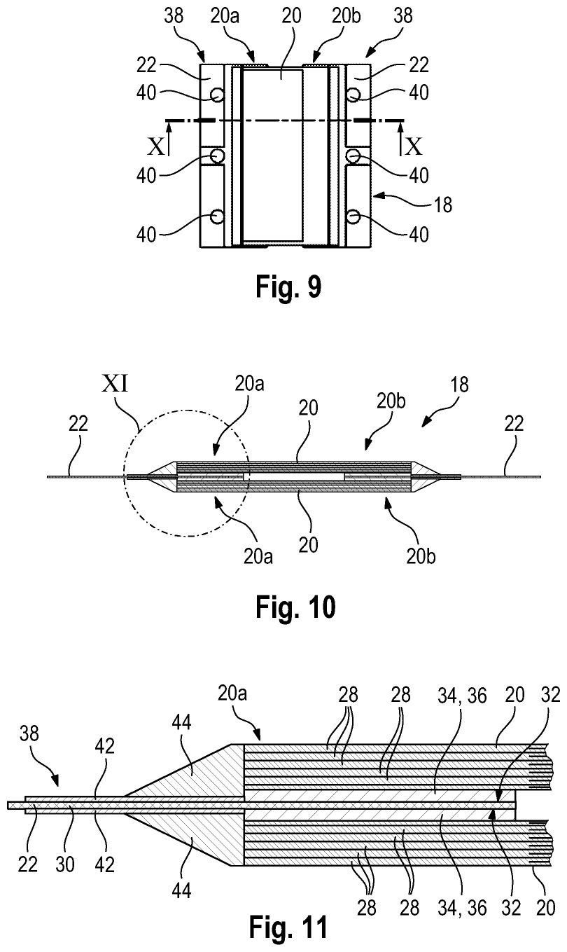

FIG. 9 shows a top view of a valve actuator according to the invention in accordance with a third embodiment,

FIG. 10 shows the valve actuator of FIG. 9 in a sectional view along the plane X-X,

FIG. 11 shows a detail XI of the valve actuator of FIG. 10,

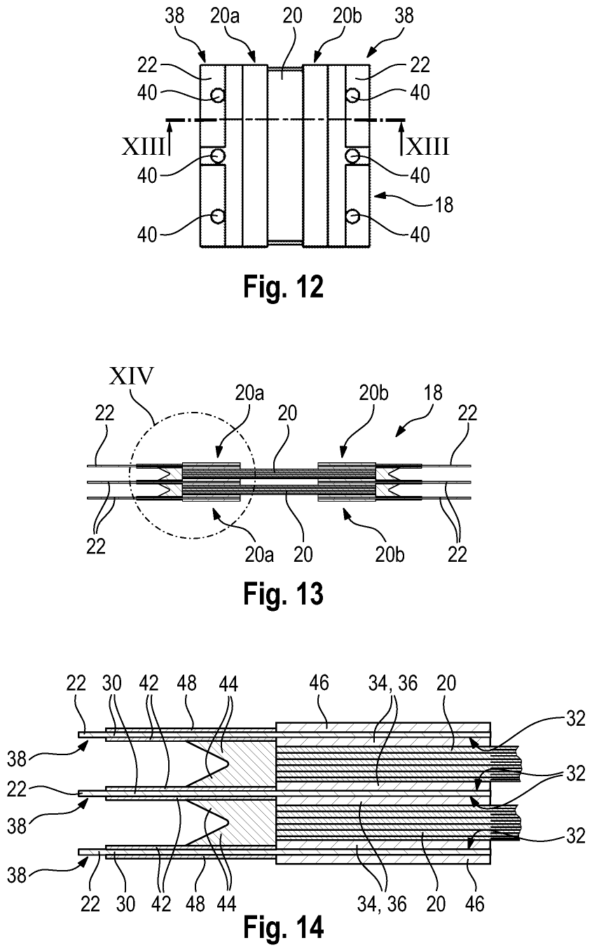

FIG. 12 shows a top view of a valve actuator according to the invention in accordance with a fourth embodiment,

FIG. 13 shows the valve actuator of FIG. 12 in a sectional view along the plane XIII-XIII,

FIG. 14 shows a detail XIV of the valve actuator of FIG. 13,

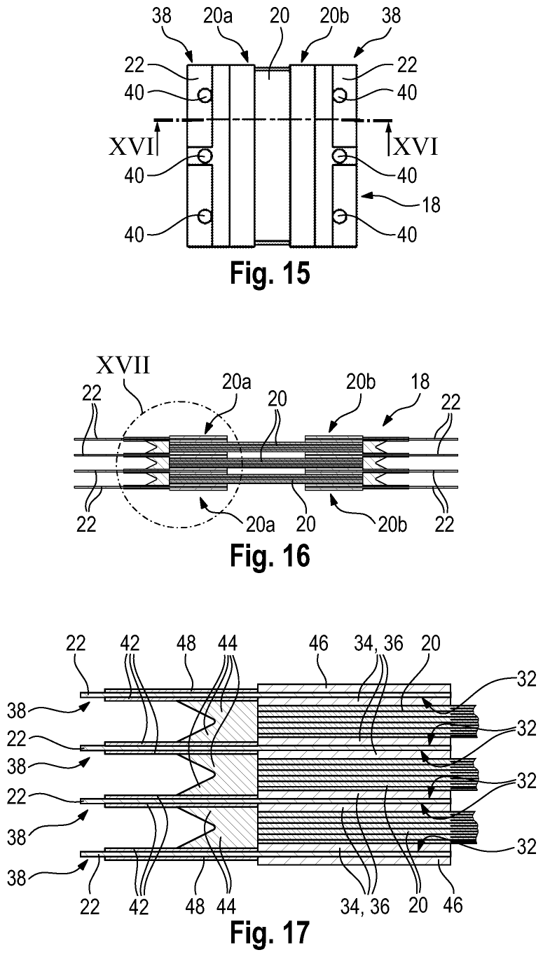

FIG. 15 shows a top view of a valve actuator according to the invention in accordance with a fifth embodiment,

FIG. 16 shows the valve actuator of FIG. 15 in a sectional view along the plane XVI-XVI,

FIG. 17 shows a detail XVII of the valve actuator of FIG. 16, and

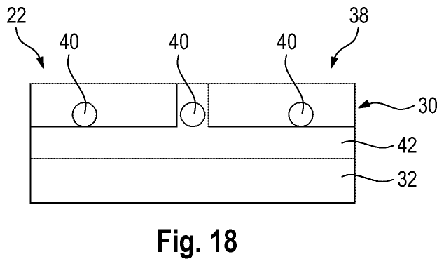

FIG. 18 shows a top view of the fundamental structure of a connection element of a valve actuator according to the invention.

In the following, the basic structure of a valve 10 is shown with reference to FIGS. 1 and 2. Even though two different embodiments are shown here (the valve of FIG. 1 has an adjustment device that is not further relevant here and is not present in the embodiment of FIG. 2), the two figures are described in parallel.

The valve 10 has a valve housing 12 and a valve actuator housing 14. Two fluid ports are provided on the valve housing 12 and can selectively be fluidically coupled or fluidically separated from each other by an actuation of the valve 10. In FIG. 1, only the fluid port 16b is shown; the fluid port 16a is located “at the rear” of the valve housing and can be seen in FIG. 2.

For actuating the valve, a valve actuator 18 is provided within the valve actuator housing 14, which has a dielectric elastomer converter module (in short: converter module) 20 having two opposite ends 20a, 20b.

Each end 20a, 20b is provided with a connection element 22.

The connection element 22 arranged at the top (with reference to the figures) serves to mechanically couple the valve actuator 18 to a retaining part 24 of the valve 10.

The connection element 22 arranged at the bottom (with respect to the figures) is mechanically coupled to an actuating part 26 of the valve 10.

The valve 10 shown is designed as a so-called normally open (NO) valve. In an unpowered state of the valve actuator 18, the valve 10 is therefore open. It is understood that by a corresponding adaptation of the retaining part 24 and the actuating part 26, the valve actuator 18 can also be used in so-called normally closed (NC) valves.

The valve actuator 18 may be designed according to a first embodiment shown in FIGS. 3 to 5.

The converter module 20 is multilayered. It thus comprises a plurality of layers 28 each including one pair of electrodes and an elastomer film.

In the first embodiment, a total of five layers 28 is provided.

Referring to FIGS. 4 and 5, the layers are stacked in a vertical direction. This direction is perpendicular to the direction in which the converter module acts during operation, i.e. shortens or lengthens. This direction of action of the converter module is horizontal in FIGS. 4 and 5.

The connection elements 22 respectively associated with the ends 20a, 20b, respectively, are here designed as identical parts, so that it is sufficient in the following to describe the connection element 22 connected to the end 20a. The connection element 22 connected to the end 20b has an identical structure and is coupled to the end 20b in the same manner.

The connection element 22 has a connection element body 30 which, in the illustrated example embodiment, is made of a plastic material. Specifically, this is a PET film.

Alternatively, the connection element body 30 may be made of a ceramic material.

The connection element body 30 is also substantially plate-shaped. The same applies to the connection element 22 as a whole.

On the side shown at the top in FIG. 5, the connection element 22 has an adhesive surface 32 to which the converter module 20 is connected via an adhesive bond 34. More specifically, the end 20a of the converter module 20 associated with the connection element 22 is connected to the adhesive surface 32 via an adhesive layer 36.

In this case, the adhesive bond serves for both force application and electrical contacting.

For a mechanical coupling of the connection element 22 to the retaining part 24 or the actuating part 26, it further has a coupling section 38.

In the illustrated embodiment, the latter comprises a total of three fastening openings 40, so that the connection element 22 can be screwed to the retaining part 24 or the actuating part 26.

The valve actuator 18 is further configured such that a modulus of elasticity of the connection element 22 is greater than a modulus of elasticity of the adhesive bond 34.

Furthermore, the modulus of elasticity of the adhesive bond 34 is greater than the modulus of elasticity of the converter module 20. This results in a stepwise increase of the modulus of elasticity starting from the converter module 20 up to the connection element 22.

The converter module 20 is also electrically coupled to the connection element 22. Thus, current can be supplied to the electrodes present within the converter module 20 via the connection element 22, so that the valve actuator 18 can be actuated. For this purpose, an electrically conductive coating section 42 which is electrically contacted to the converter module 20 via a conductive paste section 44 is provided on the connection element 22.

Based on the illustration in FIG. 5, it is also apparent that the connection element 22 is configured to be expandable.

In this context, an expansion adhesive layer 46 and an electrically conductive expansion coating section 48 are provided on a side of the connection element body 30 shown at the bottom in FIG. 5.

They can be used in the course of expanding the valve actuator 18 by a further converter module 20.

It will be understood that expandability may also be dispensed with by dispensing with the expansion adhesive layer 46 and the conductive expansion coating portion 48.

The connection element 22 is shown isolated in FIG. 18.

The valve actuator 18 may alternatively be designed according to a second embodiment shown in FIGS. 6 to 8. In the following, only the differences to the first embodiment will be discussed. Elements of the valve actuator 18 which are identical or correspond to each other are provided with the same reference numerals.

The ends 20a, 20b of the converter module 20 are now each provided with two connection elements 22. Here, each end 20a, 20b is positioned between the associated connection elements 22.

Accordingly, in the illustration according to FIG. 8, the converter module 20 is connected both on a side illustrated at the top and on a side illustrated at the bottom to the connection element 22 arranged above and below the converter module 20, respectively, in FIG. 8, via an adhesive bond 34.

The valve actuator 18 is mechanically coupled to the retaining part 24 and the actuating part 26 by means of two respective coupling sections 38, each connection element 22 having one of them.

For an electrical contacting of the converter module 20, both connection elements 22 have an electrically conductive coating section 42. The latter is electrically contacted to the converter module 20 via a respective conductive paste section 44. The conductive paste sections 44, which are assigned to different connection elements 22 which are however arranged at the same end 20a, 20b, merge into one another.

The valve actuator 18 according to the second embodiment is expandable on both sides.

Thus, it has an expansion adhesive layer 46 and an electrically conductive expansion coating section 48 on each of its side illustrated at the top of FIG. 8 and its side illustrated at the bottom of FIG. 8.

The valve actuator may also be configured according to a third embodiment shown in FIGS. 9 to 11. This embodiment will be explained below based on the first embodiment, only the differences thereto being discussed. Elements of the valve actuator 18 which are identical or correspond to each other bear the same reference numerals.

The valve actuator 18 according to the third embodiment has a total of two connection elements 22, which are arranged at opposite ends of the valve actuator 18. However, a total of two converter modules 20 are now also provided.

They are arranged parallel to each other, so that the ends 20a of the two converter modules 20 are each located on one side and the ends 20b are each located on an opposite side.

The ends 20a are connected to opposite sides of the same connection element 22.

The same applies to the ends 20b, which are also connected to opposite sides of the same connection element 22.

The couplings between the converter modules 20 and the connection elements 22 correspond both mechanically and electrically to those of the embodiments already discussed.

With regard to the first embodiment (see in particular FIG. 5), the third embodiment thus made use of the possibility of expansion.

The valve actuator 18 can alternatively be designed according to a fourth embodiment, which is illustrated in FIGS. 12 to 14. Again, only the differences to the embodiments already explained will be discussed. Elements of the valve actuator 18 which are identical or correspond to each other bear the same reference numerals.

The valve actuator now comprises a total of two converter modules 20, which extend in parallel as already explained with regard to the third embodiment.

Adjacent ends 20a, 20b of the converter modules 20 each accommodate one connection element 22 therebetween.

In addition, the respective externally located sides of the converter modules 20 are each provided with a connection element 22 at their ends 20a, 20b. Thus, the ends 20a, 20b of external converter modules 20 are each connected to two connection elements 22.

The structure of the valve actuator 18 according to the fourth embodiment can thus be regarded as an expansion of the structure of the valve actuator 18 according to the second embodiment.

The electrical and mechanical coupling of the converter modules 20 to the connection elements 22 corresponds to what has already been explained.

A further, fifth embodiment of the valve actuator 18 is shown in FIGS. 15 to 17. Again, only the differences to the embodiments already explained are discussed, elements of the valve actuator 18 which are identical or correspond to each other being provided with the same reference numerals.

A plurality of parallel converter modules 20 are again provided.

Here, the structure of the valve actuator 18 according to the fourth embodiment has been expanded by a further converter module 20 and by a further connection element 22 at each end 20a, 20b.

The electrical and mechanical couplings are obtained as already explained.

1. A valve actuator for a valve, comprising a dielectric elastomer converter module having two opposite ends, each end being provided with at least one connection element for coupling the valve actuator to a retaining part and an actuating part of the valve, respectively, characterized in that each end is connected to the respectively associated connection element via an adhesive bond.

2. The valve actuator according to claim 1, characterized in that the connection elements are identical parts.

3. The valve actuator according to claim 1, characterized in that the dielectric elastomer converter module is electrically coupled to at least one connection element.

4. The valve actuator according to claim 3, characterized in that the dielectric elastomer converter module is electrically connected to an electrical conductor track and/or an electrically conductive coating section of the connection element.

5. The valve actuator according to claim 3, characterized in that the dielectric elastomer converter module is electrically coupled to the at least one connection element via a conductive paste section and/or an electrically conductive adhesive section.

6. The valve actuator according to claim 1, characterized in that each of the connection elements has a coupling section for mechanical connection to the retaining part and/or to the actuating part of the valve.

7. The valve actuator according to claim 1, characterized in that the connection element is substantially plate-shaped, in particular wherein an adhesive surface is provided for forming the adhesive bond.

8. The valve actuator according to claim 1, characterized in that the dielectric elastomer converter module is single-layered or multilayered.

9. The valve actuator according to claim 1, characterized in that a modulus of elasticity of the connection element is greater than a modulus of elasticity of the adhesive bond, in particular wherein the modulus of elasticity of the adhesive bond is greater than a modulus of elasticity of the dielectric elastomer converter module.

10. The valve actuator according to claim 1, characterized in that each end of the elastomer converter module is provided with a total of two connection elements, each end being positioned between the respectively associated connection elements.

11. The valve actuator according to claim 1, characterized in that a further dielectric elastomer converter module is provided which extends substantially parallel to the dielectric elastomer converter module, ends of the elastomer converter modules corresponding to each other being each connected to the same connection element.

12. The valve actuator according to claim 11, characterized by a plurality of dielectric elastomer converter modules extending in parallel, adjacent ends of the elastomer converter modules each receiving a connection element therebetween, in particular wherein the ends of externally located elastomer converter modules are each connected to two connection elements.

13. The valve actuator according to claim 1, characterized in that a connection element body of the connection element is made of an electrically non-conductive material, in particular a ceramic material or a plastic material.

14. A valve actuator for a valve, comprising a dielectric elastomer converter module having two opposite ends, each end being provided with at least one connection element for coupling the valve actuator to a retaining part or an actuating part of the valve, respectively, characterized in that each end is connected to the respectively associated connection element via an adhesive bond, the elastomer converter module being formed from a plurality of stacked layers, the direction in which the layers lie one on top of the other being perpendicular to the direction in which the elastomer converter module acts during operation, the adhesive bond serving both for fastening and force application and for electrical contacting.

15. A valve comprising a valve actuator according to claim 1, a first connection element being coupled to a retaining part and a second connection element being coupled to an actuating part of the valve.
